(19) United States
(12) Patent Application Publication
(10) Pub. No.: US 2005/0091830 A1
(43) Pub. Date: May 5, 2005

(54) Method and apparatus for providing thermal breaks in profiles

(76) Inventor: Marc Van Den Bulcke, Ville St-Laurent (CA)

Correspondence Address: JACK PAAVILA, BOX 1151, ALEXANDRIA, KOC IA0, CA

(21) Appl. No.: 10/698,465

(22) Filed: Nov. 3, 2003

(51) Int. Cl. B23P 11/00; B21D 39/00

(52) U.S. Cl. 29/514; 29/505

(57) ABSTRACT

A method for securely mounting an elongated, insulating strip in an elongated metal profile section, the strip having opposed longitudinal edges and the profile section having an elongated groove with a slightly open mouth. The method comprises placing one edge of the strip into the elongated groove in the profile section, the strip extending out of the groove and the groove loosely holding the strip and then partly closing the mouth of the groove, simultaneously along the entire length of the groove, onto the strip to securely retain the strip to the profile section. An apparatus for use in forming a thermal break between a pair of profile sections, each profile section having an elongate groove along its length, and an insulating strip loosely held in the grooves and extending between the sections. The apparatus is a press having a bed to support a first die; the first die holding the first and a second profile sections in place, slightly spaced apart, parallel to each other, and with the grooves facing. The first die is at least as long as the profile sections. The press has a member carrying a second die spaced from the first die, the second die at least as long as the grooves. Moving means on the press relatively move the second die toward the first die for partly closing the grooves in the profile sections, simultaneously along their entire length, onto the strip to securely hold the strip to the profile sections.

### BACKGROUND OF THE INVENTION

1. Field of the Invention

This invention is directed toward a method, and an apparatus, for providing thermal breaks in profiles.

2. Description of the Related Art

Metal profiles are used in the construction of window frames, door frames and like frame structures. The profiles are cut in lengths into frame members and the frame members are joined to provide a structural frame. The frame usually has an inner frame and an outer frame and a thermal break is provided between the inner and outer frames to prevent heat loss. The profiles used in the frame are normally made with one profile section providing the inner frame, another profile section providing the outer frame, and an insulating member joining the profile sections.

The insulating member forming the thermal break usually is in the form of a narrow bar or strip and is initially relative loosely mounted by its longitudinal edges in opposing grooves in the profile sections. After the insulating strip is mounted in the grooves, the grooves are then partly closed or crimped onto the strip to securely retain the strip in place in the grooves. The grooves are usually closed by relatively moving the profile sections, with the strip in place in the grooves, past one or more crimping members which members crimp portions of the profile material, adjacent the grooves, onto the insulating strip to hold it in place.

Usually the crimping members are rollers as is shown in U.S. Pat. Nos. 3,420,026 and 3,992,769 by way of example. However, it takes a relatively long time to move the rollers, relative to the profile sections, over the length of the sections and thus is a slow process and therefore costly. Further, the rollers tend to bend the sections when the sections are moved relative to the rollers, particularly when the sections are relatively thin. Bent profile sections are unacceptable and either the relative movement between the roller and profile section has to take place at a lower speed to minimize bending and/or the bent profile sections have to be straightened after rolling to be useful. In either case the process is furthered slowed and thus more costly.

### SUMMARY OF THE INVENTION

It is the purpose of the present invention to provide a method, and an apparatus for carrying out the method, which allows the insulating strip to be quickly, easily, and securely mounted in the profile sections thereby reducing the cost of the operation. It is a further purpose of the present invention to minimize bending of the profile sections during installation of the mounting strips.

In accordance with the present invention, the insulating strip is initially loosely mounted in the grooves in the profile sections by its longitudinal edges and then the entire length of the grooves are simultaneously partly closed or crimped onto the strip to securely retain it in place in the profile sections. By simultaneously partly closing the entire length of the grooves, the process is greatly speeded up. In addition, the profile sections are not subjected to moving localized forces, such as when using rollers, which cause the sections to bend.

The apparatus for carrying out the method comprises a press, at least as long as the profile sections being used, with a first die mounted on the bed of the press. The first die has means for holding the profile sections with the grooves in the sections facing each other. An insulating strip is mounted between the profile sections with the edges of the strip loosely mounted in the grooves. The press carries a second die spaced from the first die and mounted on a press arm of the press. The second die is normally as long as the first die. Movement of the press arm will move the second die toward the first die. During this movement the second die moves part of the profile sections adjacent the grooves to pinch or crimp the grooves to hold the strip in place. This crimping action takes place simultaneously along the entire length of both grooves. Being able to crimp the grooves simultaneously all along the length of the profile sections in one operation greatly speeds up the operation. Also, being able to crimp the grooves simultaneously along the entire length of the profile sections minimizes bending of the profile sections.

The invention is particularly directed toward a method for securely mounting an elongated, insulating strip in an elongated, metal profile section, the strip having opposed longitudinal edges and the profile section having an elongated groove with a slightly open mouth. The method comprises placing one edge of the strip into the elongated groove in the profile section, the strip extending out of the groove and the groove loosely holding the strip. The mouth of the groove is then partly closed onto the strip to securely retain the strip to the profile section, the closing taking place simultaneously along the entire length of the groove, .

The invention is also directed toward a press for use in forming a thermal break between a pair of profile sections, each profile section having an elongate groove along its length and an insulating strip loosely held in the grooves and extending between the sections. The press has a bed to support a first die. The first die has holding means for holding the first and second profile sections in place, slightly spaced apart, parallel to each other, and with the grooves facing. The first die is at least as long as the profile sections. The press has a member carrying a second die spaced from the first die, the second die also at least as long as the profile sections. The press has moving means for moving the second die toward the first die to have the dies cooperate to partly close the grooves in the profile sections, simultaneously along their entire length, onto the strip to securely hold the strip to the profile sections.

### BRIEF DESCRIPTION OF THE DRAWINGS

FIG. 1 is a cross-section view of an insulating strip;

FIG. 2 is a cross-section view of a pair of profile sections to be joined by the strip;

FIG. 3 is a cross-section detail view of part of the press;

FIG. 4 is a detail cross-section view showing the profile sections and strip mounted in the press at the start of pressing;

FIG. 5 is a detail cross-section view similar to FIG. 4 but at the completion of pressing;

FIG. 6 is a cross-section view of another insulating strip;

FIG. 7 is a cross section view of a another pair of profile sections;

FIG. 8 is a cross-section detail view of the press;

FIG. 9 is a detail cross-section view showing the profile sections and strips mounted in the press at the start of pressing;

FIG. 10 is a detail cross-section view similar to FIG. 9 but at the completion of pressing.

### DESCRIPTION OF THE PREFERRED EMBODIMENTS

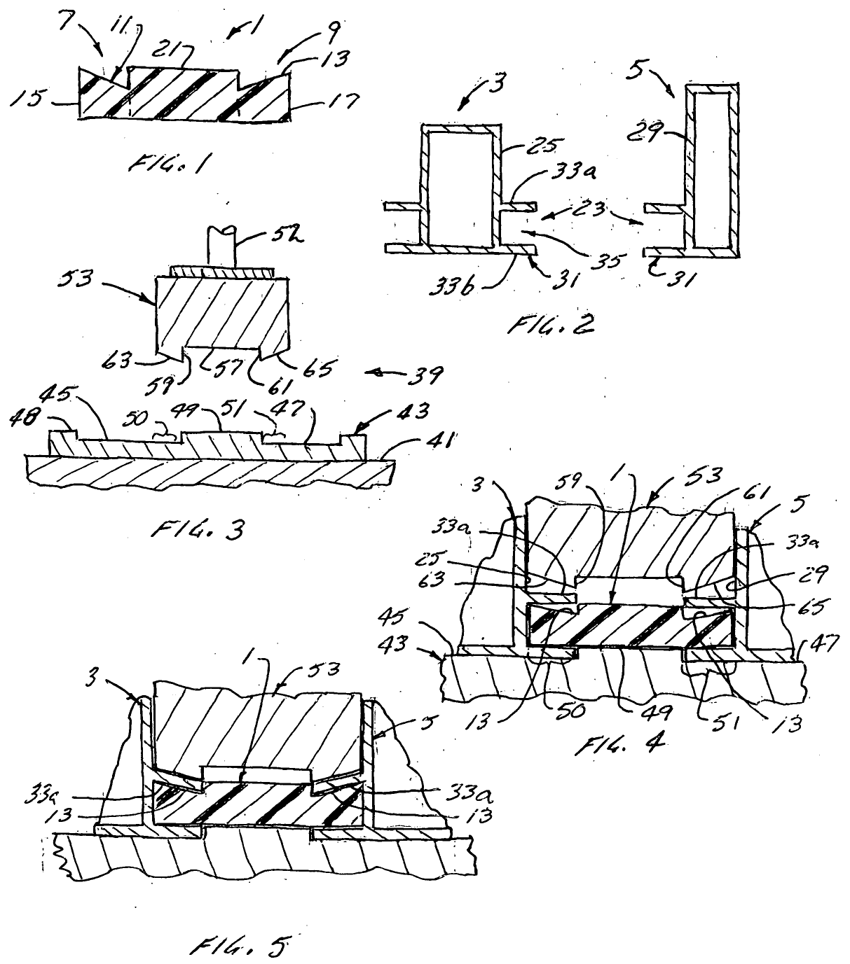

An elongated insulating strip 1 is to be mounted between two metal profile sections 3, 5. The strip 1, as shown in FIG. 1, has two opposed edge portions 7, 9, the edge portions forming first connecting means. One side 13 of the edge portions 7, 9 is beveled slightly inwardly from the outer edges 15, 17 of the strip, as shown, so that the outer edges 15, 17 of the edge portions 7, 9 are wider than the inner portion 19 of the edge portions. The beveled sides 13 are on the same wide side 21 of the strip. The strip 1 is preferably made suitable plastic material, although it can be made from other suitable insulating material.

The first profile section 3, as shown in FIG. 2, has second connecting means 23 on one side wall 25 of the section and the second profile section 5 also has second connecting means 23 on one side wall 29. The second connecting means 23 comprises a groove 31 formed by a pair of flanges 33a, 33b projecting laterally from the side walls 25, 29. The flanges 33a, 33b are parallel and define an open mouth 35 on the groove 31.

The apparatus for mounting the strip 1 between the profile sections 3, 5 is a press 39, as shown in FIG. 3, having a bed 41 on which is mounted a first die 43. The first die 43 has shallow slots 45, 47 in its top surface 48 in which the profile sections 3, 5 respectively, can be mounted to prevent lateral movement. The area of the die between the slots 45, 47 forms a wide shoulder 49 for supporting the strip as will be described. The narrow areas 50, 51 of the bottoms of the slots 45, 47 adjacent the shoulder 49 support the lower flanges 33b of the profile sections 3, 5 as will be described.

The press 39 has a press arm 52 above the first die 43 carrying a second die 53 facing the first die 43. The leading face of the second die 53 has a shallow central slot 57 defining two spaced-apart shoulders 59, 61. The outer faces 63, 65 of the shoulders 59, 61 respectively can be slightly beveled away from each other as shown.

At least the narrow areas 50, 51 adjacent the wide shoulder 49 in the first die 43 are an unbroken length, as long as the length of the die, to properly support the profile sections 3, 5 during the crimping operation. Similarly, at least the shoulders 59, 61 in the second die 53 are an unbroken length, as long as the length of the die, to properly carry out the crimping operation along the entire length of the profile sections simultaneously. The first and second dies 43, 53 can be removably mounted on the bed 41 and press arm 51 respectively so that various dies can be used to fit different profile sections.

In use, with the dies 43, 53 spaced apart, the profile sections 3, 5 are mounted in the slots 45, 47 in the first die 43 on the bed 41 of the press 37 as shown in FIG. 4 with their side walls 25, 29 facing each other and with the bottom flanges 33b of their grooves 31 resting on the narrow areas 50, 51 of the bottom of the slots 45, 47. The strip 1 is then mounted between the profile sections 3, 5 with the edge portions 7, 9 of the strip loosely mounted in the grooves 31 in both profile sections. By ‘loosely’ it is meant, throughout this applciation, that the strip 1 free to easily slide in the grooves 31 but has little lateral movement. The strip 1 is mounted to have the beveled sides 13 of the edge portions 7, 9 facing toward the second die 53. The main central portion of the strip 1, between the edge portions 7, 9, rests on the wide shoulder 49 of the first die 43 and the edge portions 7, 9 of the strip 1 rest on the bottom flange 33b of the grooves. The top flange 33a of the grooves 31 overlies the beveled sides 13 of the strip. The strip 1 can be mounted in the profile sections 3, 5 by sliding it inwardly between the grooves 31 formed by the flanges 33a, 33b.

Once the profile sections 3, 5 and strip 1 are mounted in place on the first die 43, the second die 53 is moved toward the first die 43 by suitable moving means (not shown) on the press. The shoulders 59, 61 on the second die 53 simultaneously bend the top flange 33a of the grooves 31 on the profile sections, over their entire length on each side, downwardly onto the strip 1 against the beveled sides 13, as shown in FIG. 5, in a manner to slightly close the mouths 35 of the grooves 31 so as to securely retain the strip 1 in the grooves the pressing action applied by the shoulders 59, 61 is resisted by the narrow areas 50, 51 on the first die 43 which areas are aligned with the shoulders 59, 61 throughout their respective lengths.

The movement of the second die 53 toward the first die 43 is controlled by the press to ensure that the second die only moves the necessary amount to bend the top flange 33a firmly against the strip. Physical stops (not shown) can be provided on the dies to limit their movement toward each other. Alternatively, the moving means of the press can be programmed to move the second die the required amount for the specific shape of strip and profile sections being connected. The die must move enough to securely join the strip and profile sections as determined by known industry standards but not so much as to damage the edge portions 7, 9 of the insulating strip 1.

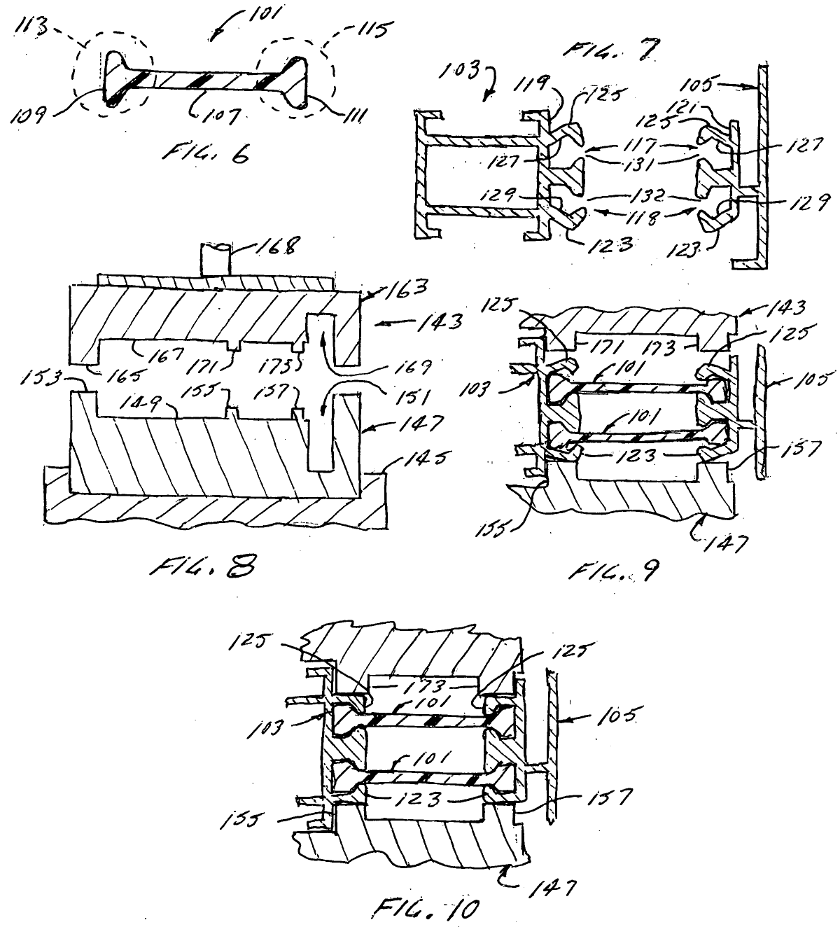

In a preferred embodiment of the invention, two insulating strips 101 are used to join two profile sections 103, 105 together. The insulating strip 101, in this embodiment as shown in FIG. 6, has a central web 107 with a narrow flange 109, 111 at each end, the flanges 109, 111 extending transverse to the web 107. The flanges 109, 111 and an adjacent portion of the web 107 form two opposed edge portions 113, 115 on the strip. The profile sections 103, 105 in this embodiment each have two T-shaped grooves 117, 118 on one side 119, 121 respectively as shown in FIG. 7. The portions 123, 125 of the profile sections 103, 105 defining the outer sides 127, 129 of the two grooves 117, 118 are bent slightly outwardly away from each other to slightly open the mouths 131, 132 of the grooves.

The press 143 used to mount the two strips 101 between the profiles 103, 105 has a bed 145 on which is mounted a first die 147 as shown in FIG. 8. The first die 147 has first and second slots 149, 151 in its top surface 153, the slots receiving the bottom portions of the profiles 103, 105. The first die 147 also has the top surface 153 cut away between the two slots 149, 151 to form two projecting shoulders 155, 157, one shoulder 155 adjacent slot 149 and the other shoulder 157 adjacent slot 151. The press 143 has a press arm 161 carrying a second die 163. The second die 163 faces the first die 147 and has a bottom surface 165 in which are formed two slots 167, 169 to loosely receive the top portions of the profile sections 103, 105. The bottom surface 165 of the second die 163 is cut away between the two slots 167, 169 to form two projecting shoulders 171, 173, one shoulder 171 adjacent slot 167 and the other shoulder adjacent slot 169. The shoulders 171, 173 in the second die are aligned with the shoulders 155, 157 in the first die. At least the shoulders 155, 157 in the first die 147 and at least the shoulders 171, 173 in the second die 163 have a continues unbroken length, as long as the length of the dies, to properly support the profile sections 103, 105 over their entire length during the crimping operation.

In use, the two profile sections 103, 105 are mounted in the slots 149, 151 respectively in the first die 147 with their sides 119, 121 facing ach other. In this position, the bent portions 123 of the profile sections, defining the outer side of the bottom grooves 117, rest on the shoulders 155, 157 of the first die 147. The second die 163 is raised during the positioning of the profile sections on the first die. The second die 163 is then lowered by the moving means on the press until it nearly abuts the first die 147, enclosing the tops of the profile sections, and having its shoulders 171, 173 just touch the upper bent portions 125 of the profile sections. The two insulating strips 101 are then loosely inserted into the grooves 117, 118 in the two profile sections 103, 105 to extend between them. As the strips are slid into the grooves to extend between the profile sections, a knurling device could be pulled ahead of them through the grooves 117, 118 to roughen the sides of the grooves so as to more securely grip the insulating strips 101.

Once the two strips 101 are installed in place in the profile sections 103, 105, the second die 163 is moved again to abut its bottom surface 165 against the top surface 153 of the first die 147. The top surface 153 of the first die 147 acts as a stop for the bottom surface 165 of the second die 163 to limit the movement of the second die. As the second die 163 moves, both the bottom shoulders 155, 157 and the top shoulders 171, 173 on the first and second dies respectively bend the outer bent portions 123, 125 on both the profiles, simultaneously over the length of the two strips 101, toward the edge portions 113, 115 of the strips to partly close the mouths 131, 132 of the grooves 117, 118 to securely lock the strips in the grooves. The operation bends all four bent portions 123, 125 on the profiles simultaneously so that the operation is extremely quick.

As in the first embodiment, the movement of the second die 163 toward the first die 147 is controlled by the press to ensure that the second die only moves the necessary amount to bend both the top and bottom die portions 123, 125 firmly against the strip 101. Physical stops, such as, for example, the surfaces 153, 165 on the dies 147, 163, can be provided to limit their movement toward each other. Alternatively, the moving means of the press can be programmed to move the second die the required amount for the specific shape of strip and profile sections being connected. The die must move enough to securely join the strip and profile sections as determined by known industry standards but not so much as to damage the edge portions 113, 115, of th insulating strip 1.

The two embodiments described above use specific cooperating shapes for the grooves in the profile sections, and the edges of the insulating strips, to position and then lock the strips between the profile sections. Other cooperating shapes can be used to define the grooves and the strip edges.

While the two embodiments described use bendable locking portions on the profile sections to secure the insulating strips, the portions of the profile sections adjacent the grooves, which grooves hold the edges of the strips, could also be deformed instead of bent to secure the strips in the grooves, the deformation partly closing the mouths of the grooves.

The dies on the press can be easily changed to suit the shape of the profiles to joined by the insulating strip or strips. While both embodiments describe the first die as being fixed and the second die moving toward the first die, both dies can move simultaneously toward each other.

1. A method for securely mounting an elongated, insulating strip in an elongated metal profile section, the strip having opposed longitudinal edges and the profile section having an elongated groove with a slightly open mouth; the method comprising: placing one edge of the strip into the elongated groove in the profile section, the strip extending out of the groove and the groove loosely holding the strip; and then partly closing the mouth of the groove, simultaneously along the entire length of the groove, onto the strip to securely retain the strip to the profile section.

2. A method as clamed in claim 1 wherein the other edge of the strip is mounted into an elongated groove in a second profile second, the second groove having a slightly open mouth to loosely hold the other edge of the strip, and partly closing the mouth of the second groove, simultaneously along the entire length of the groove, onto the strip to securely retain the strip to the second profile section.

3. A method as claimed in claim 3 wherein the grooves in the profile sections are partly closed simultaneously with each other.

4. A method as claimed in claim 3 including the step of mounting the first and second profile sections on a first die in a press with the grooves in the profile sections facing each other, placing the strip in the grooves while the profile sections are on the die, and then relatively moving a second die in the press toward the first die to provide the partial closing of the mouths of the grooves simultaneously along their entire length.

5. A method as claimed in claim 4 wherein the grooves are roughened during mounting the strip in the groove.

6. A method for providing a thermal break between two adjacent elongate metal profile sections, each profile section having first and second elongate parallel grooves in one side of the profile section, each groove having an outer side and an inner side, the inner sides adjacent, the outer sides slightly bent away from each other, each groove having a slightly open mouth; the method comprising the steps of: mounting the profile sections to have the one side of one profile section facing the one side of the other profile section; mounting two insulating strips between the profile sections, each strip having opposed longitudinal edges; one strip having its edges loosely in the first grooves in the profile sections, the second strip having its edges loosely in the second grooves in the profile sections; and moving the outer sides of the first grooves in the profile sections onto both edges of the first strip simultaneously along their entire length to securely hold the first strip to the profile sections, and moving the outer sides of the second grooves in the profile sections onto both edges of the second strip simultaneously along their entire length to securely hold the second strip to the profile sections.

7. A method as claimed in claim 6 wherein the outer sides of the first grooves are moved simultaneously with the outer sides of the second grooves.

8. A method as claimed in claim 7 wherein the profile sections are mounted in a first die and a second die is relatively moved toward the first die to effect the simultaneous moving of the outer sides of the first and second grooves.

9. A method as claimed in claim 8 wherein the amount of movement of the second die relative to the first die is controlled to avoid damaging the strip while securely fastening the strip to the profile sections.

10. An apparatus for use in forming a thermal break between a pair of profile sections, each profile section having an elongate groove along its length and an insulating strip loosely held in the grooves and extending between the sections; the apparatus being a press having a bed to support a first die; the first die holding the first and a second profile sections in place, slightly spaced apart, parallel to each other, and with the grooves facing; the first die at least as long as the profile sections; the press having a member carrying a second die spaced from the first die, the second die at least as long as the grooves, and moving means on the press for relatively moving the second die toward the first die for partly closing the grooves in the profile sections, simultaneously along their entire length, onto the strip to securely hold the strip to the profile sections.

11. An apparatus for use in forming a thermal break between a pair of profile sections, each profile section having a first side with first and second elongate, parallel, slightly open, grooves therein, and first and second insulating strips extending between the profile sections, each strip having opposed longitudinal edges, the first strip loosely held by its edges in the first grooves in the profile sections, the second strip loosely held by its edges in the second grooves in the profile sections; the apparatus comprising a press having a bed and a first die mounted on the bed, the first die holding the profile sections with first and second insulating strips extending between the profile sections, the first die at least as long as the profile sections; a second die opposite the first die, the second die at least as long as the profile sections; and moving means for relatively moving the second die toward the first die to cause the first die to crimp the profile sections adjacent the first grooves simultaneously along the length of the strip onto the first strip and to cause the second die to crimp the profile sections adjacent the second grooves simultaneously along the length of the strip onto the second strip to securely hold the strips to the profile sections.

12. An apparatus as claimed in claim 11 including stop means on the dies for limiting the movement of the first and second dies toward each other to control the amount of crimping.

13. An apparatus as claimed in claim 12 wherein the stop means comprise cooperating surfaces on the dies that abut to limit movement of the second die toward the first die.

14. An apparatus as claimed in claim 11 wherein the first and second dies each have spaced-apart projecting shoulders for contacting outer portions of the profile sections adjacent the grooves, the shoulders on the second die aligned with and facing the shoulders on the first die, the shoulders moving these outer portions as the second die moves relatively toward the first die to crimp the profile sections adjacent the grooves.

15. An apparatus as claimed in claim 12 wherein the first and second dies each have spaced-apart projecting shoulders for contacting outer portions of the profile sections adjacent the grooves, the shoulders on the second die aligned with and facing the shoulders on the first die, the shoulders moving these outer portions as the second die moves relatively toward the first die to crimp the profile sections adjacent the grooves.
